(19) United States
(12) Patent Application Publication
(10) Pub. No.: US 2008/0269921 A1
(43) Pub. Date: Oct. 30, 2008

(54) System and Method for Providing Support Assistance

(75) Inventors: Amit Banerji, Bangalore (IN); William Isaiah Fenner, Keller, TX (US); Saieb Alsafi, Dubai (AE)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: ACCENTURE GLOBAL SERVICES GMBH, Schaffhausen (CH)

(21) Appl. No.: 11/742,205

(22) Filed: Apr. 30, 2007

(51) Int. Cl. G05B 13/02

(52) U.S. Cl. 700/49

(57) ABSTRACT

A system and method for providing support assistance and guidance include the creation of process maps and use of such maps in a service application. Process maps may be created using a creation tool that embeds interactive features in process steps. The interactive features may include the activation of an application, linking of a website and/or the display of an image or document. Process maps may be associated with clients/customers, applications and/or issue categories. Users may use and follow the process map to aid customers in resolving various issues such as technical questions and troubleshooting. Tracking and logging components may be used to track information relating to a case including the interactions of a support personnel and/or information entered. Compliance may also be measured based on, for example, an amount of time spent on various processes. Change management system may also be used to manage changes made to process maps.

### BACKGROUND

Providing customer or client support and assistance in a variety of industries can involve significant costs that may include staffing costs, training costs and equipment costs. For example, training often requires teaching support personnel about the various issues that may arise and possible resolutions. In addition, training may also include familiarizing staff with various technologies and systems. Such extensive training is often needed to cover as many scenarios as possible so that staff may provide adequate support to customers without the need to constantly place customers on hold while the staff person seeks other assistance herself. In some instances, support staff may also be required to access applications that might not be linked to a support application. As such, the support staff must be trained to know which applications need to be accessed and where to find those applications.

Using current methods and systems of providing support, compliance of support processes and staff with predefined standards are often difficult to determine. If personnel take longer than necessary to address a particular step in a resolution process, that time often goes undetected and thus, uncorrected or unaddressed. This may lead to longer than intended wait times for customers as well as increase costs associated with providing customer support.

For the foregoing reasons, a system and method for providing support assistance is needed.

### SUMMARY

A method and system for providing support to customers using predefined process maps that include embedded interactive features allows support personnel to analyze and resolve an issue with less training. The predefined process maps may be created using a creation tool that receives data for defining process steps in an issue resolution process. The data may include detail information that provides interactive features for process steps. For example, a process step may be embedded with a link to an application that should be used in addressing that process step. In another example, a process step may include a link to a website that provides information on how to resolve an issue. Once the process steps have been defined and the process map created, the creation tool may validate the map and publish it for use in a service application. Process maps may be stored in a knowledge database and sorted based on various parameters such as by client, by type of issue and/or by application to which the process map pertains.

According to one or more aspects, a service application may use the predefined process maps to guide personnel in providing customer support and/or service. The service application may include a logging component that tracks information regarding a particular customer case. For example, the logging component may track time spent on each process step or over multiple process steps. In addition, actions performed by the support personnel and/or information submitted by the customer may be logged automatically. The service application may further include a search bar for searching for various topics and a menu for selecting different process maps.

In one or more further aspects, a change management system may be used to process and manage changes made to process maps. The change management system may determine the impact of a change of one process map on one or more other process maps. In one or more instances, review or management personnel may be alerted to the submitted change and the change's potential impact. The changes may be submitted for approval and once approved, the changes may be implemented. Further, changes might only be submitted for approval if other process maps are impacted. Alternatively, change may be submitted for approval regardless of whether the change would effect or impact on other process maps. If changes are not approved, they may be discarded.

These as well as other advantages and aspects of the invention are apparent and understood from the following detailed description of the invention, the attached claims, and the accompanying drawings.

### BRIEF DESCRIPTION OF THE DRAWINGS

The present invention is illustrated by way of example and not limited in the accompanying figures in which like reference numerals indicate similar elements and in which:

FIG. 1 illustrates a block diagram of a computing environment in which one or more aspects described herein may be implemented.

FIG. 2 illustrates a block diagram of a system for providing support assistance according to one or more aspects described herein.

FIG. 3A illustrates a user interface for a service application for providing support assistance according to one or more aspects described herein.

FIG. 3B illustrates a case note entry dialog box according to one or more aspects described herein.

FIG. 4 is a flowchart illustrating a method for providing assistance in resolving support issues using process maps according to one or more aspects described herein.

FIG. 5 is a flowchart illustrating a method for generating process maps according to one or more aspects described herein.

FIG. 6 illustrates compliance indicators for measuring compliance with one or more standards according to one or more aspects described herein.

FIG. 7 is a flowchart illustrating a method for process a change to a process map according to one or more aspects described herein.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

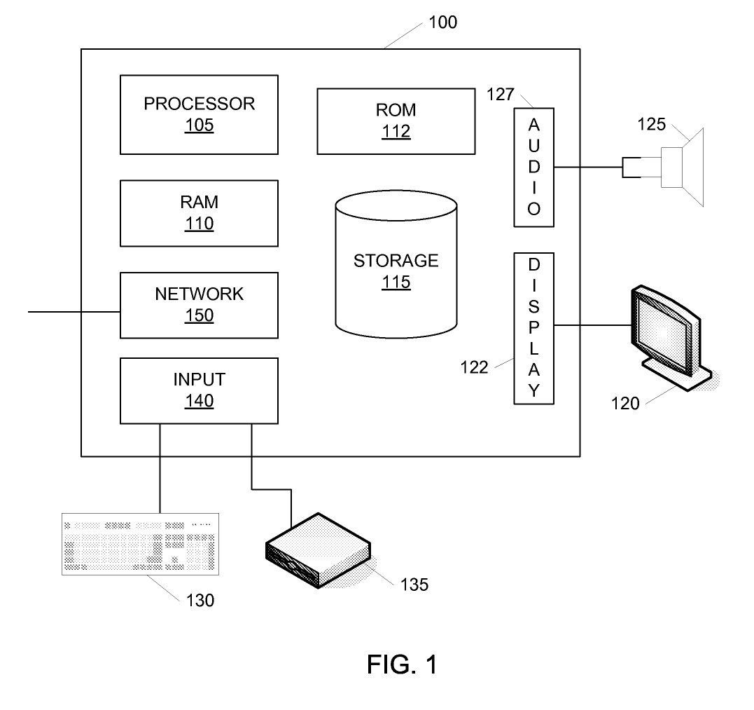

FIG. 1 illustrates a computing environment in which one or more aspects described herein may be implemented. A computing device such as computer 100 may house a variety of components for inputting, outputting, storing and processing data. For example, processor 105 may perform a variety of tasks including executing one or more applications, retrieving data from a storage device such as storage 115 and/or outputting data to a device such as display 120. Processor 105 may be connected to Random Access Memory (RAM) module 110 in which application data and/or instructions may be temporarily stored. RAM module 110 may be stored and accessed in any order, providing equal accessibility to the storage locations in RAM module 110. Computer 100 may further include Read Only Memory (ROM) 112 which allows data stored thereon to persist or survive after computer 100 has been turned off. ROM 112 may be used for a variety of purposes including for storage of computer 100's Basic Input/Output System (BIOS). ROM 112 may further store date and time information so that the information persists even through shut downs and reboots. In addition, storage 115 may provide long term storage for a variety of data including applications and data files. Storage 115 may include any of a variety of computer readable mediums such as disc drives, optical storage mediums, magnetic tape storage systems, flash memory and the like. In one example, processor 105 may retrieve an application from storage 115 and temporarily store the instructions associated with the application RAM module 110 while the application is executing.

Computer 100 may output data through a variety of components and devices. As mentioned above, one such output device may be display 120. Another output device may include an audio output device such as speaker 125. Each output device 120 and 125 may be associated with an output adapter such as display adapter 122 and audio adapter 127, which translates processor instructions into corresponding audio and video signals. In addition to output systems, computer 100 may receive and/or accept input from a variety of input devices such as keyboard 130, storage media drive 135 and/or microphone (not shown). As with output devices 120 and 125, each of the input devices 130 and 135 may be associated with an adapter 140 for converting the input into computer readable/recognizable data. In one example, voice input received through microphone (not shown) may be converted into a digital format and stored in a data file. In one or more instances, a device such as media drive 135 may act as both an input and output device allowing users to both write and read data to and from the storage media (e.g., DVD-R, CD-RW, etc.).

Computer 100 may further include one or more communication components for receiving and transmitting data over a network. Various types of networks include cellular networks, digital broadcast networks, Internet Protocol (IP) networks and the like. Computer 100 may include adapters suited to communicate through one or more of these networks. In particular, computer 100 may include network adapter 150 for communication with one or more other computer or computing devices over an IP network. In one example, adapter 150 may facilitate transmission of data such as electronic mail messages and/or financial data over a company or organization's network. In another example, adapter 150 may facilitate transmission or receipt of information from a world wide network such as the Internet. Adapter 150 may include one or more sets of instructions relating to one or more networking protocols. For example adapter 150 may include a first set of instructions for processing IP network packets as well as a second set of instruction associated with processing cellular network packets. In one or more arrangements, network adapter 150 may provide wireless network access for computer 100.

One of skill in the art will appreciate that computing devices such as computer 100 may include a variety of other components and is not limited to the devices and systems described in FIG. 1.

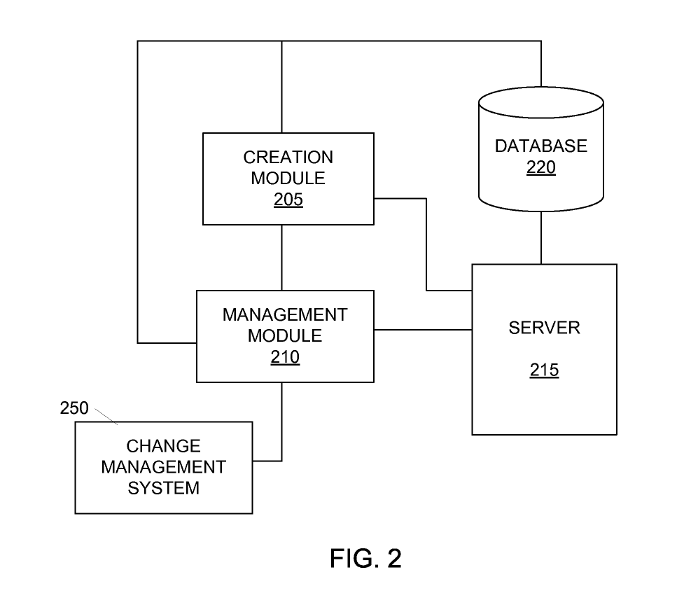

FIG. 2 illustrates a system for providing service assistance that may include creation module 205, management module 210 and server 215. Each of modules 205, 210 and 215 may include hardware, software, firmware or combinations thereof. Creation module 205 may be configured to generate process maps that are used to aid service personnel with guiding a customer in resolving service issues. A process map, as used herein, generally relates to a collection of process steps that are linked to form a process flow. Using a process map, a customer support specialist or other service personnel may identify steps to take based on information provided by a customer seeking support. The process map may further include embedded interactive features such as links to applications, applets, images, documents and/or websites. For example, a step in the process map may correspond to editing a customer's profile. Accordingly, a link to the profile editing application or applet may be embedded or otherwise associated with the process step. In one example, creation module 205 may include a drawing or drafting application such as MICROSOFT VISIO by Microsoft Corporation of Redmond, Wash. Creation module 205 may include additional components for embedding detail information (e.g., interactive features) in objects created with a drawing application. Additionally, creation module 205 may include a conversion component to convert a process map from a VISIO format to a hypertext markup language (HTML) format and to publish process maps in multiple formats and in multiple locations simultaneously.

In one or more configurations, creation module 205 may be supported using class libraries such as those available through MICROSOFT .NET FRAMEWORK. Creation module 205 may further be configured to read details of a published HTML page and capture data entered into or associated with the published HTML process blocks. This functionality may facilitate a real-time audit trail that may automatically capture the data associated with each process blocks and store the captured information (e.g., in a pop-up dialog box). The automatic capture and storage of notes and data of a case may help reduce time spent per call by eliminating the need to manually enter case notes into a case management tool.

Once a process map is created (e.g., by creation module 205), the map may be transmitted and stored in server 215 and/or database 220. Server 215 may include an organizational platform such as MICROSOFT OFFICE SHAREPOINT SERVER. Server 215 may act as a data repository and facilitate the retrieval and transmittal of requested data through a network (e.g., an intranet, extranet or a wide area network like the Internet). Data generated in either creation module 205 or management module 210 may be received and stored by server 215 in an internal and/or external database such as database 220.

Management module 210 may be configured to aid support personnel in resolving an issue raised by a client. Management module 210 may comprise a computer device such as computer 100 of FIG. 1. According to one or more aspects, management module 210 may provide support personnel with a user interface that allows the user to select an issue, a client requesting support and/or an application associated with the issue. Management module 210 may then retrieve the appropriate process map from server 215 and present the process map to the user. Further, management module 210 may coordinate the activation of various applications associated with one or more process steps in the process map. Management module 210 may further be configured to receive data corresponding to the resolution of the customer's issue. Such data may include notes entered by the support personnel, recordings of the conversation with the customer, time spent on one or more process steps, applications used and/or steps followed. This data may be stored as a log for later review and auditing. In one or more instances, the logged data may be sent to server 215 and/or database 220 for storage.

In one or more arrangements, a conversion system may include or be connected to a change management system such as system 250. Change management system 250 may be an Information Technology Infrastructure Library (ITIL) defined, dynamic, web based process that manages all process maps. Using change management system 250, enterprise wide changes to process maps may be made quickly. The changes made may be reflected in real-time, allowing a user to detect and perceive the changes as they occur. In some cases, changes to one process map may affect the formulation of another process map. Change management system 250 may facilitate the modification of the second process map based on changes made to the first process map. For example, link dependences may automatically be updated in a second process map if one or more process steps are removed from a first process map.

Additionally or alternatively, change management system 250 may track changes by logging how, when and by who a change was made. Change management system 250 may include a change roll back feature that allows an enterprise or organization to return to a previous version of one or more process maps. To provide such a roll back feature, change management system 250 may include an archive (not shown) configured store previous version of a process map as well as records of changes made. Change management system 250 may further provide storage of multiple process map versions at one time. Thus, a user may be allowed to choose the version of a process map he or she wishes to use.

Change management system 250 may also be backed up by a workflow system (not shown) that supports auditing, editing and approval of changes. As such, compliance of a change with respect to one or more predefined rules or standards may be monitored to insure that compliant changes are being made. In addition, change relation feature may be included in system 250 to provide a user the ability to determine the number of and identify the process maps or other items that may be impacted by a change. Using change management system 250, a user may further specify a change to be automatically published or instituted once approval is received.

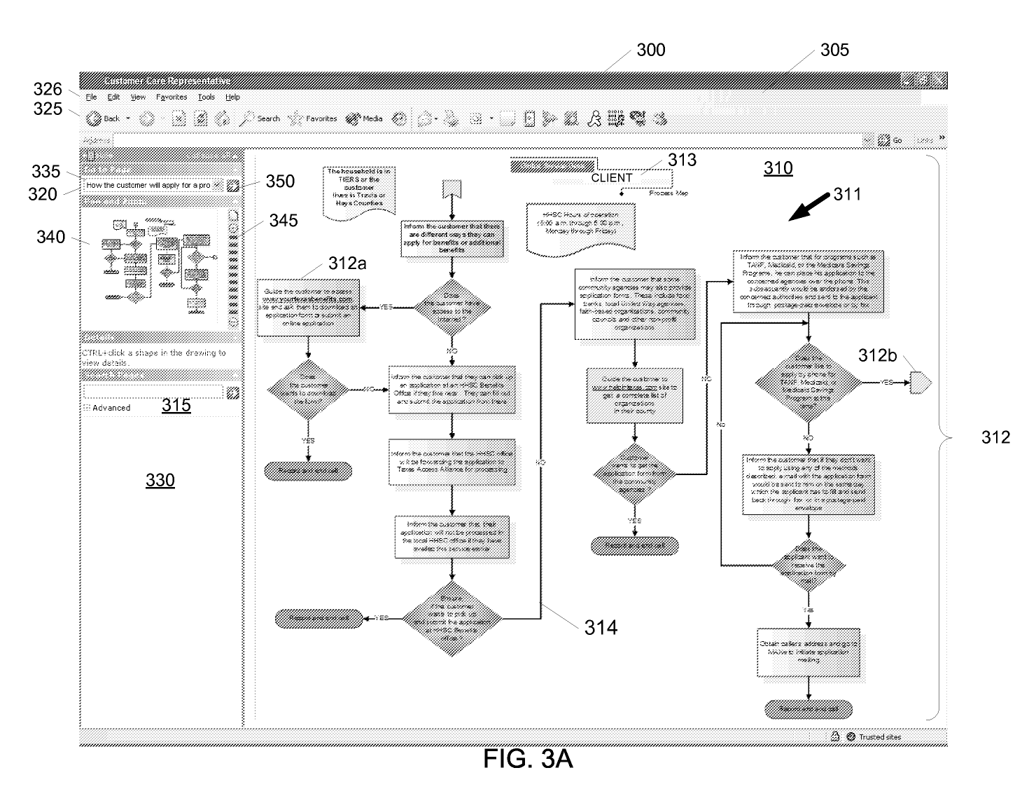

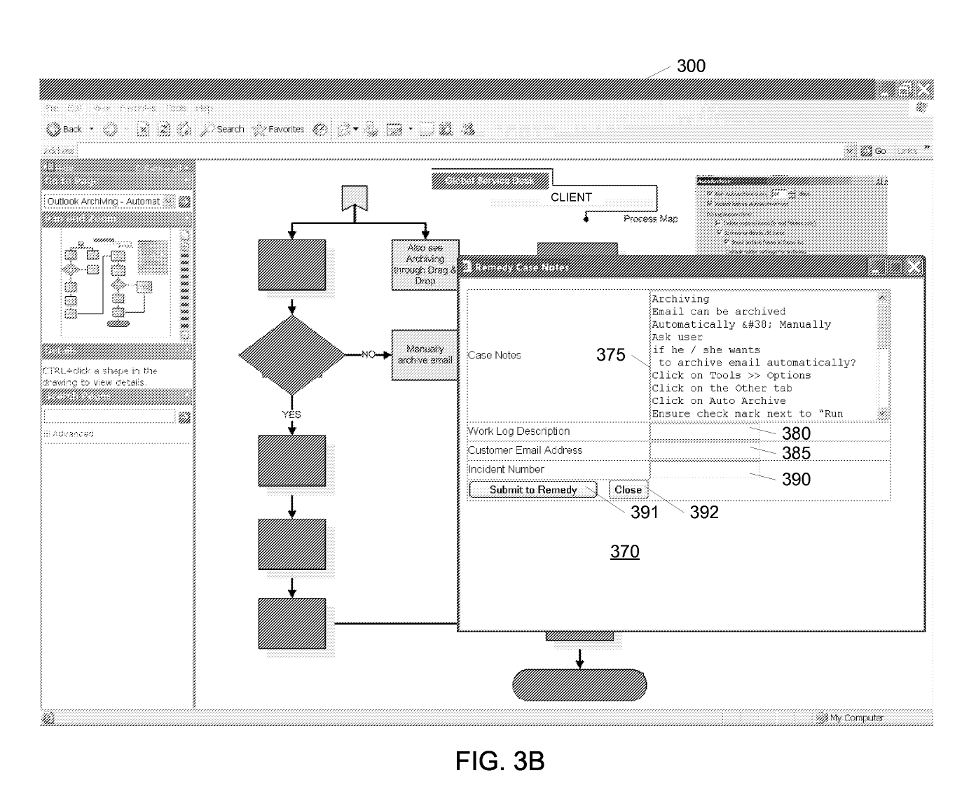

FIG. 3A illustrates an example user interface that may be displayed to support personnel in resolving a service issue. Interface 300 may include application window 305 having process map display area 310, search bar 315 and process map selection tool 320. A variety of other tools and functions may also be provided in, e.g., tool bars 325 and 326.

Application window 305 may correspond to a variety of applications including web or shell browser applications and third-party applications. In one example, the process map may be formatted according to HTML format. Accordingly, the process map may be loaded using a web browsing application such as MICROSOFT INTERNET EXPLORER or FIREFOX by the Mozilla Foundation. Process map display area 310, search bar 315 and process map selection tool 320 may be displayed in separate portions of window 305. Window 305 may be user-configurable allowing map area 310, search bar 315 and selection tool 320 to be displayed and positioned in a variety of configurations. For example, map area 310, search bar 315 and selection tool 320 may be displayed or positioned within the same area or region of window 305.

Process map display area 310 includes process map 311 having process blocks 312 and client identifier 313. Client identifier 313 may be used to specify the client for which service or support is being requested and currently provided. Process maps may be defined and created based on specific client needs and specifications. For example, a first client's systems may include features that are not available in a second client's systems. As such, the process map for resolving issues relating to the two clients' systems may be different based on the difference in available features and/or differences in the level of support needed (e.g., one client may be technology savvy while another client might not be as technology literate). Process blocks 312 represent various steps that may be involved in resolving a given issue. Process blocks 312 may, in one or more configurations, use flowchart shapes to represent the different types of process steps involved, as shown in FIG. 3A. For example, decision steps may be represented by diamonds while processes may be represented by rectangles. Links 314 between process blocks 312 may indicate a direction in which the process should proceed in addition to decision indicators such as “YES” and “NO.”

Process blocks 312 may include detail information such as a description of the step, questions to pose to the customer and/or potential solutions. Additionally, process blocks 312 may include links to websites, associations to applications, links to other process maps and other interactive features. For example, process block 312a includes a link to a website while process block 312b includes a link to the next page (not shown) of the process map. In one or more configurations, each of process blocks 312 may include a menu (not shown) that may be activated by a predefined command or type of interaction such as clicking a right mouse button. The menu may include the available interactive features associated with that process block and step. One of ordinary skill in the art will appreciate that a variety of applications, links and other interactive features may be embedded and associated with process blocks 312.

Search bar 315 may be included in interface 300 to allow a user to search for information within a knowledge database (e.g., database 220 of FIG. 2). The knowledge database may act as a repository for data relating to the resolution of potential issues. For example, known solutions and workarounds may be added to the knowledge database based on actual experiences. Search bar 315 may also provide searching of other information sources such as on-line databases. In one example, searches entered into search bar 315 may be run on an on-line search engine in addition to the search performed on the local knowledge database. Results may be displayed in result display area 330 of window 305, in a separate window (not shown) or a combination thereof.

In process map selection tool 320, menu 335 may be used to select a process map from multiple available process maps. Preview pane 340 may also be provided to allow a user to preview a selected process map before sending the process map to display area 310. Menu 335 may be populated with information based on a specified client, support issue type, application for which support is requested and the like. Preview pane 340 may include control 345 that allows a user to pan and zoom the selected process map within pane 340. Confirmation button 350 may also be included in selection tool 320 to allow a user to confirm his or her selection of process maps. Once confirmed, the process map may be transmitted to and displayed in display area 310.

According to one or more aspects, selecting one of process steps 312, e.g., process step 312a, may activate an interactive feature such as a case note recordation tool. FIG. 3B illustrates user interface 300 displaying case note recordation dialog box 370 that may be activated upon selection of (or other type of interaction with) process block 312a. Note recordation box 370 includes note entry area 375, log description field 380, contact information field 385, incident ID field 390 and case notes options 391 and 392. Notes area 375 may be provided to allow a user to enter notes about a particular incident. For example, a user may note the various resolutions that were tried and whether those resolutions were successful. Log description field 380 may be used to enter a description or name that may be used to identify a note in an activity log. That is, rather than displaying the entire note in a process log, the description or name of the note may be displayed instead. Alternatively or additionally, the note and the log description may be displayed together. Contact information may include an e-mail address, a phone number, a fax number, a mailing address and the like. The incident number may correspond to a number assigned to the particular case or incident for which the note is being entered.

Case note dialog box 370 may include submit option 391 and close option 392. Submit option 391 may allow the user to submit the notes to be stored with the incident in the database. Alternatively or additionally, submitting the notes may cause the information entered to be submitted to other personnel and/or to another system for further evaluation and analysis. Close option 392 allows the user to close dialog box 370 and return to the process map or to a previous screen. A variety of other options may also be included such as a clear options to clear all the fields and a save option to allow a user to save information intermittently.

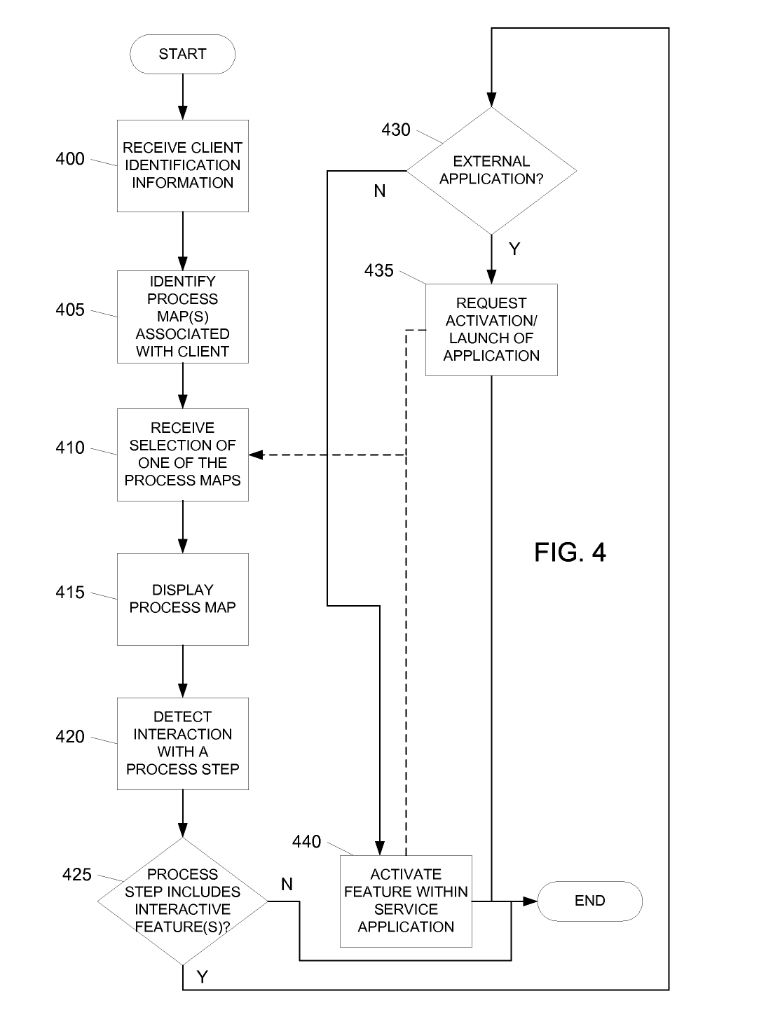

FIG. 4 is a flowchart illustrating a method for providing support guidance in resolving one or more issues. In step 400, a service application may receive information identifying a client requesting support for a particular issue. Issues may range from needing troubleshooting help to requiring guidance on how to perform a particular function to requesting general information relating to an application, device or system. A client may be identified by name or by a predefined code associated with the client. For example, each client in a database may be assigned an ID number or an ID code made up of a sequence of alphanumeric characters. In step 405, the service application may identify one or more process maps associated with the client based on the client identification information. Process maps may be defined for specific clients and may thus be associated in a database with the specific clients' identification information. In one example, a table may be used to store associations between a client and one or more process maps corresponding to that client.

In step 410, the service application may receive a selection of one of the process maps. The selection may be made manually by a user or automatically based on entered information about a type of support issue, an application associated with the issue and/or a general support topic. In response to the selection, the process map may be displayed in an area (e.g., display area 310 of FIG. 3A) of a user interface in step 415. In step 420, the service application may detect and/or receive interaction with one or more of the process steps of the process map. Interaction may include a user selecting one of the process steps, movement of a cursor in specified areas of a process map display area, interactive voice commands and the like. Interaction may be facilitated using a variety of tools including a user's finger or a stylus for touch sensitive displays, a mouse, a keyboard, a microphone, a joystick and/or combinations thereof. In step 425, the service application may determine whether the process step targeted by the interaction includes interactive features. As discussed, interactive features may include the launching of an application or an applet, linking to a website, activating a log and the like. If the process includes an interactive feature, in step 430, the service application may determine whether an external application is associated with the process step. An external application, as used herein, relates to an application that is executed separately from another application. Thus, an external application of the service application may be an application that is run outside of or separately from the service application.

In step 435, if an external application is associated with the process step, the service application may request the activation of the external application. For example, the service application may transmit a request to an underlying operating system to launch the specified program. According to one or more arrangements, data that is entered or accessed in an external application may be logged by the service application. Various methods and systems may be used to log external application interactions including key loggers and other components that may intercept information being transmitted from or received by the system and/or the external application.

If, however, the interactive feature or process step is not associated with an external application, the service application may activate the interactive feature within the service application in step 440. In one example, a process step may be associated with a note feature or applet that allows a user to enter notes about the customer, the issue and/or the case in general. As such, upon interaction with the process step, the note applet or function may be activated and displayed to the user within the service application. In another example, selecting or interactive with a particular process step may cause an image (e.g., an example screenshot) to be displayed within the service application. The process may loop back to step 410 where further interactions may be detected.

Additionally, as a user guides a customer or client through the process map, the activities of the user and the information submitted by the client or user may be tracked automatically in a data file such as an activity log. In one or more configurations, the service application may initiate a background process that tracks the amount of time spent on each process step, the actions taken by the support personnel (e.g., clicking on a link, activating an application or applet), notes taken by the support personnel and other related information. A tracker or logger may be activated automatically upon selection of a process map or activation of the service application. Alternatively or additionally, logging activation may be controlled manually by a user.

According to one or more aspects, process maps may be retrieved from a database based on information other than or in addition to client identification. For example, process maps may be linked to a specified type of issue or a particular application. Thus, in one or more arrangements, a user may select the application with which support is being requested to obtain a list of available process maps. A user may be presented with a menu that allows her to select and enter various selection parameters (e.g., application, client ID, issue type) with which to retrieve process maps. In another example, once a user has selected a client, he may further refine the process maps retrieved based on the client information by entering other specifications such as application and/or issue type.

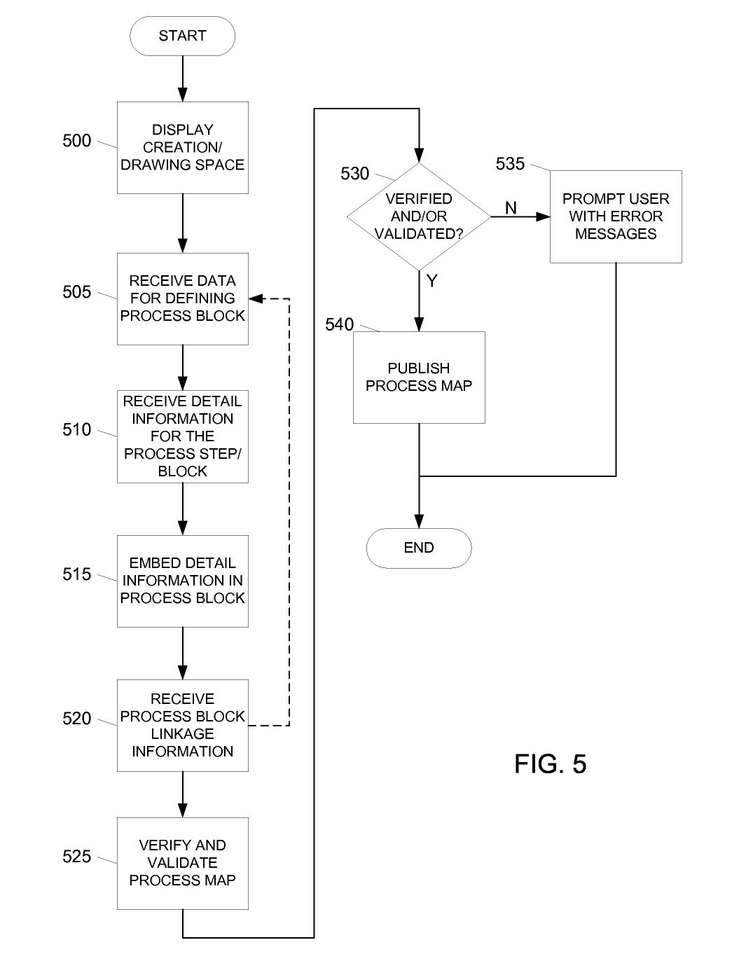

FIG. 5 is a flowchart illustrating a method for creating process maps. In step 500, a creation tool may initially display a drawing or creation space for a user to define process steps in the process map. In step 505, the creation tool may receive input corresponding to data defining a process step. In one or more configurations, the creation tool may be graphical in nature and allow a user to define the size and shape of a process block representing a process step. In one example, a user may wish to use a diamond shape to represent decision steps and rectangular blocks to represent process steps. As such, process step data may include the dimensions and shape of a process block and/or a position/placement of the process block. In step 510, the creation tool may receive further data corresponding to detail information associated with a process step. Detail information may include text or other data displayed in the process block corresponding to the process step, associations with other process steps or blocks, interactive features and the like.

Upon receiving the detail information in step 510, the creation tool may embed the data into the appropriate process block in step 515. Data to be displayed to a user may be added to the visual appearance of the process block while associations with other applications or applets may be embedded as an activated feature. For example, a screenshot, or a link thereto, may be embedded in a process block such that the image is shown upon a user selecting the process block or an option associated therewith. The types of interactions that trigger an interactive feature or a menu may also be defined in the detail information. In one example, the detail information is defined in a properties form of the particular process blocks. The detail information stored in the properties may include an image, a hyperlink to another process map or a website, an auto capture rule for case notes, a hyperlink that invokes a tool or application and/or keywords for searching.

In step 520, the creation tool may receive information corresponding to linkages between process steps and blocks. That is, a user may define a process flow that is generally followed when resolving a particular issue. The linkages may be represented graphically by one or more arrows between process blocks. The method may loop back to step 505 to receive additional information relating to the definition of additional process steps and blocks.

Once a user has completed defining the process map and is ready to publish the map to a knowledge database, the creation tool may perform a verification or validation check on the process map in step 525. The verification may include insuring that all process blocks are connected, applications and other interactive features associated with process steps exist, a beginning step and an end step exist, each process block includes detail information and the like. In step 530, the creation tool may determine whether the process map has been validated or verified. If not, the creation tool may prompt the user to correct one or more detected errors in step 535. The errors may be displayed in a separate dialog box or as a message within the process map. For example, error arrows may be displayed in the process map to identify problem areas.

If, however, the creation tool is able to validate and verify the process map, the tool may publish the process map in step 540. Publishing the process map may include converting the process map from a first format to a second format. For example, a process map may initially be created in VISIO format. Once the process map is completed and finalized, the creation tool may convert the process map from VISIO format to HTML format, for example. The second format may be defined based on the capabilities of the service application in which the process map is loaded and used. Conversion and creation may be facilitated by methods and tools available through MICROSOFT .NET class libraries.

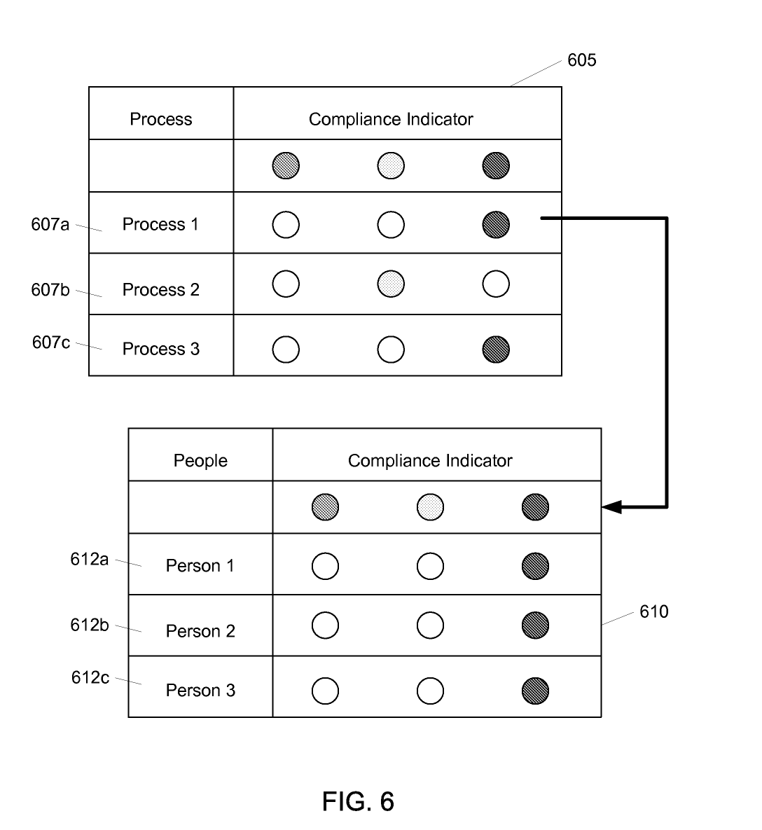

According to one or more aspects, a compliance method and system may be implemented to monitor the performances and sufficiency of the support provided by support personnel and systems. FIG. 6 illustrates a user interface displaying compliance indicators 605 and 610. Compliance indicator 605 may be configured to display compliance for each of process steps 607 in a process map while indicator 610 may be configured to display the compliance of personnel 612 for a particular process step (e.g., process step 607b). Compliance indicators 605 and 610 may each indicate performance based on three colors where each color corresponds to a level of compliance. In one example, green may indicate full compliance, yellow partial compliance and red non-compliance. A variety of indicators may be used in place of or in conjunction with the color indicators. For example, a rating of 1-10, shape indicators and/or “YES” or “NO” indicators may be used. Alternatively or additionally, compliance indicator 610 may be accessed by selecting one of the process steps of compliance indicator 605. That is, by selecting one of the process steps of indicator 605, detailed information about personnel compliance may be displayed in indicator 610.

Compliance may be determined based on various predefined rules or standards. In one or more configurations, compliance may be evaluated based on the best practices framework set by the Control Objectives for Information and related Technology (COBIT). Compliance may be measured, for example, based on the amount of time it takes for a user to complete a process step, customer polls relating to satisfaction, whether a resolution was reached, whether notes were kept, how and/or when a process tool is used and the like. Based on these factors, a score may be generated and compared to threshold levels of compliance. In one or more arrangements, a compliance level associated with a process step may be determined based on the level of compliance of personnel performing that step.

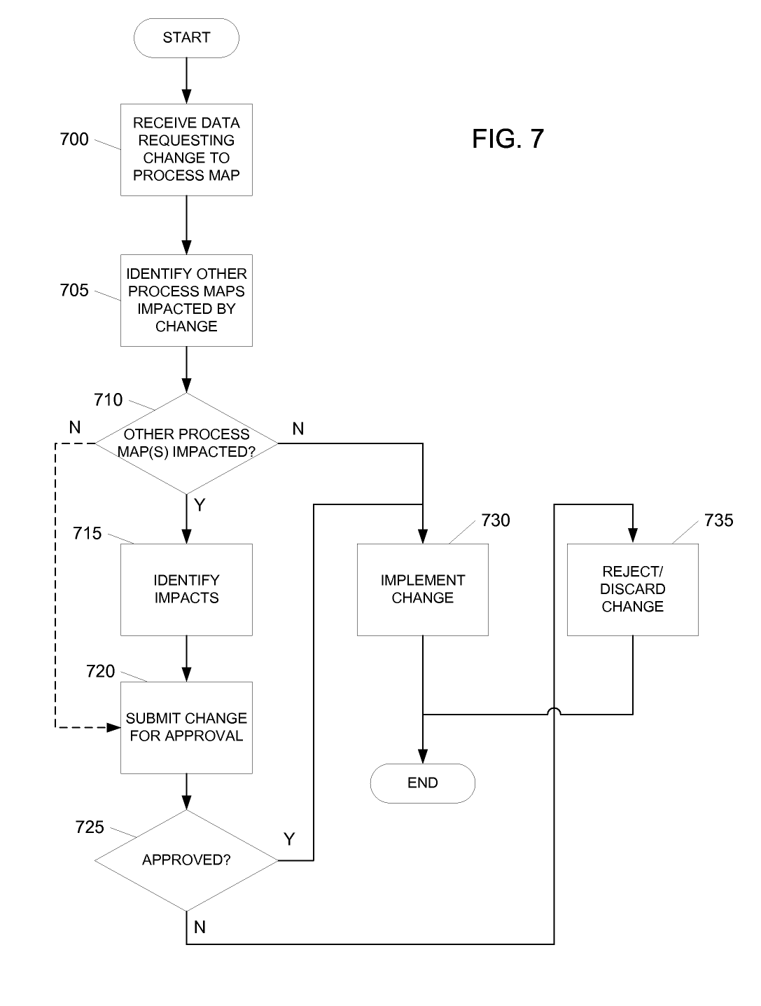

FIG. 7 is a flowchart illustrating a method for managing changes to one or more process maps. In step 700, a change management system may receive data corresponding to a requested change to one or more process blocks in a process map. For example, a user may wish to change the detail information in a process block from a hypertext link for a website to an image file link In another example, a user may wish to sever or create a link between a process block and another process map. In step 705, the change management system may identify one or more other process maps that would be impacted by the change. In the previous example, creating or severing a link between a process block and another process map may impact the existing linkages in the other process map. Impacts may be determined by identifying one or more other process maps that are connected or otherwise associated with the process block to which the change is being applied. In step 710, the change management system may determine whether other process maps are impacted based on the evaluation made in step 705. If the system determines that other process maps are impacted by the change, the system may identify the impacts in step 715. In step 720, the change may be submitted for approval. In one or more configurations, the impacts identified may also be submitted in the request for approval so that reviewing personnel is aware of the full impact of a change. In step 725, the system may determine whether the change is approved. If so, the change may be implemented in step 730. If, on the other hand, approval is not received, the change may be rejected or discarded in step 735.

If no other process maps are impacted, the change management system might not submit the change for approval and instead, automatically implement the change in step 730. Alternatively, changes that do not impact other process maps may still be sent for approval as in step 720 depending on the preferences of an organization or entity using the system. Once approved or implemented, modified process maps may further be automatically published for immediate use.

The systems and methods described herein may further include reporting systems and methods that provide reports on each process map. The reports may indicate the success rate of a process map (e.g., calculated based on an embedded algorithm). In one or more configurations, the reports may break down success rate based on individual process steps or blocks. Success rate may be determined based on a variety of factors including whether a customer's issue was fully resolved, whether the customer was happy with the service provided, frequency of use of the process map and the like. By providing reports that include information such as success rate, problem areas may be identified and improved to increase the success rate of a process map. The report may further include indicators regarding compliance of a process map with one or more rules or standards. Compliance may be measured based on one or more predefined scales.

Additionally, the methods and features recited herein may further be implemented through any number of computer readable mediums that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A computer readable medium storing computer readable instructions that, when executed, cause a processor to perform a method comprising:
receiving a process map associated with a service issue, wherein the process map includes one or more process steps defining a process flow, wherein at least one process step of the one or more process steps includes an interactive feature;
displaying the process map;
receiving user input corresponding to interaction with the at least one process step; and
in response to the user input, activating the interactive feature.

2. The computer readable medium of claim 1, wherein the process map includes a flowchart having at least one decision step.

3. The computer readable medium of claim 1, wherein the interactive feature comprises an application.

4. The computer readable medium of claim 1, wherein the at least one process step includes a hypertext link.

5. The computer readable medium of claim 1, further comprising instructions for displaying a menu providing a plurality of process maps corresponding to different service issues.

6. The computer readable medium of claim 1, wherein the process map is received in response to receiving a service request corresponding to the service issue.

7. The computer readable medium of claim 1, further comprising instructions for tracking and storing user activity associated with the process map.

8. The computer readable medium of claim 7, wherein tracking and storing the user activity includes storing notes.

9. The computer readable medium of claim 7, wherein tracking the user activity includes determining a time used for the one or more process steps.

10. The computer readable medium of claim 1, wherein the process map is displayed in hypertext markup language (HTML) format.

11. The computer readable medium of claim 1, wherein the user interaction includes a decision corresponding to a decision step and wherein the interactive feature includes retrieving and displaying another process map based on the decision.

12. A method for generating a process map, the method comprising:
receiving, at a first application, data corresponding to one or more process steps, wherein the data includes information for defining a graphical representation of each of the one or more process steps;
receiving, at the first application, detail information associated with the one or more process steps, wherein the detail information includes a link to a second application different from the first application;
embedding the detail information in the one or more process steps; and
converting the received data and the received detail information from a first format to a second format.

13. The method of claim 12, wherein the second format is readable by a third application.

14. The method of claim 13, wherein the first application corresponds to a drawing application.

15. The method of claim 12, wherein the second format includes a hypertext markup language (HTML) format.

16. The method of claim 12, wherein the detail information is embedded in the one or more process steps such that interaction with the one or more process steps causes the second application to be launched.

17. A computer readable medium storing computer readable instructions that, when executed, cause a processor to perform a method comprising:
receiving data corresponding to a change in a first process map of a plurality of process maps, the process map defining a process for resolving an issue;
determining whether the change impacts a second process map of the plurality of process maps; and
in response to determining that the change impacts the second process map, modifying the second process map in accordance with the change in the first process map.

18. The computer readable medium of claim 17, wherein the first process map includes a flowchart including one or more process blocks.

19. The computer readable medium of claim 17, wherein prior to modifying the second process map in accordance with the change in the first process map, requesting approval for the change.

20. The computer readable medium of claim 17, wherein the change corresponds to a change in detail information of a process block linked to the second process map in the first process map.
